(19) United States
(12) Patent Application Publication
(10) Pub. No.: US 2015/0163065 A1
(43) Pub. Date: Jun. 11, 2015

(54) IDENTITY AUTHENTICATION METHOD AND APPARATUS AND SERVER

(71) Applicant: Xiaolai Li, Beijing (CN)

(72) Inventors: Zhibiao Pan, Beijing (CN); Zhibin Zhang, Beijing (CN)

(21) Appl. No.: 14/557,868

(22) Filed: Dec. 2, 2014

(30) Foreign Application Priority Data
Dec. 5, 2013 (CN) 201310655393.5

(51) Int. Cl. H04L 9/32; H04L 29/06

(52) U.S. Cl. CPC H04L 9/3247; H04L 63/08; H04L 9/3242

(57) ABSTRACT

The present disclosure provides an identity authentication method and apparatus and a server. Embodiments may avoid inconvenience of input of authentication information via the input device and easy occurrence of errors in the prior art and thereby improve efficiency and reliability of identity authentication in the following manner: the authentication end encrypts the obtained token with a private key to obtain a signature so that the authentication end can send to the server the first identity identifier, the token and the signature generated according to the public key corresponding to the private key such that the server obtains the second identity identifier according to the token and the signature, and performs identity authentication according to the first identity identifier and the second identity identifier.

### BACKGROUND

1. Technical Field

The present disclosure relates to authentication technology, and particularly to an identity authentication method and apparatus and a server.

2. Description of the Related Art

As communication technology develops, a terminal integrates more and more functions so that a system function list of the terminal includes more and more corresponding applications such as applications installed in computers and applications (APP) installed in a third-party smart phone. Upon running these applications, the terminal needs to perform identify authentication in some cases, for example, posting comments, or using some designated services or logging in a personal account. In the prior art, a user uses an input device to enter a user name and a password, a client transmits the user name and password to a server, and the server may perform authentication for the user name and password transmitted by the client to achieve identity authentication of the client.

### BRIEF SUMMARY

Operations of entering authentication information such as the user name and password via the input device, for example, a switching operation between English and Chinese, and a switching operation between capitalization and lower case of letters, are very inconvenient and probably cause errors and thereby cause degradation of efficiency and reliability of identity authentication.

At least some embodiments may provide an identity authentication method and apparatus and a server to improve efficiency and reliability of identity authentication.

In an embodiment, there is provided an identity authentication method, comprising the following steps:

an authentication end obtaining a token sent by a server according to a client's access;

the authentication end encrypting the token with a private key to obtain a signature;

the authentication end sending a first identity identifier, the token and the signature to the server so that the server obtains a second identity identifier according to the token and the signature, and performs identity authentication according to the first identity identifier and the second identity identifier; wherein the first identity identifier is generated by the authentication end according to a public key corresponding to the private key.

In an embodiment, there is further provided an implementation mode, wherein the authentication end is provided in the client or independently from the client.

In an embodiment, there is further provided an implementation mode, wherein the step of the authentication end encrypting the token with a private key to obtain a signature comprises:

the authentication end performing a Hash operation for the token to obtain a Hash value of the token;

the authentication end using the private key to encrypt the Hash value of the token to obtain the signature.

In an embodiment, the step of the server obtaining a second identity identifier according to the token and the signature, and performing identity authentication according to the first identity identifier and the second identity identifier comprises:

the server performing a Hash operation for the token to obtain a Hash value of the token;

the server obtaining the public key corresponding to the signature according to the Hash value of the token and the signature;

the server generating the second identity identifier according to the public key corresponding to the signature;

the server performing an operation of passing the identity authentication if the second identity identifier accords with the first identity identifier.

In an embodiment, before the authentication end encrypts the token with a private key to obtain the signature, the method further comprises:

the authentication end, according to a website to be accessed, selects a set of secret key information as the private key and the public key corresponding to the private key.

In an embodiment, the step of the server performing an operation of passing the identity authentication comprises:

the server obtaining the user account corresponding to the first identity identifier according to the first identity identifier;

the server sending service data related to the user account to the client.

In an embodiment, there is provided an identity authentication apparatus, comprising:

an obtaining unit configured to obtain a token sent by a server according to a client's access behavior;

a signing unit configured to encrypt the token with a private key to obtain a signature;

a sending unit configured to send a first identity identifier, the token and the signature to the server so that the server obtains a second identity identifier according to the token and the signature, and performs identity authentication according to the first identity identifier and the second identity identifier; wherein the first identity identifier is generated according to a public key corresponding to the private key.

In an embodiment, the authentication apparatus is provided in the client or independently from the client.

In an embodiment, the signing unit is configured to

perform a Hash operation for the token to obtain a Hash value of the token;

use the private key to encrypt the Hash value of the token to obtain the signature.

In an embodiment, the apparatus further comprises a selection unit configured to, according to a website to be accessed, select a set of secret key information as the private key and the public key corresponding to the private key.

In an embodiment, a server comprises:

an allocating unit configured to allocate a token to a client according to the client's access behavior;

a transmitting unit configured to transmit the token to the authentication end so that the authentication end uses the private key to encrypt the token to obtain a signature;

a receiving unit configured to receive the first identity identifier, the token and the signature transmitted by the authentication end, wherein the first identity identifier is generated by the authentication end according to the public key corresponding to the private key;

an authentication unit configured to obtain a second identity identifier according to the token and the signature, and perform identity authentication according to the first identity identifier and the second identity identifier.

In an embodiment, the authentication unit is configured to

perform a Hash operation for the token to obtain a Hash value of the token;

obtain the public key corresponding to the signature according to the Hash value of the token and the signature;

generate the second identity identifier according to the public key corresponding to the signature;

perform an operation of passing the identity authentication if the second identity identifier accords with the first identity identifier.

In an embodiment, the authentication unit is configured to

obtain the user account corresponding to the first identity identifier according to the first identity identifier;

send service data related to the user account to the client.

An embodiment may facilitate avoiding inconvenience of input of authentication information via the input device and easy occurrence of errors in the prior art and thereby improve efficiency and reliability of identity authentication in the following manner: the authentication end encrypts the obtained token with a private key to obtain a signature so that the authentication end can send to the server the first identity identifier, the token and the signature generated according to the public key corresponding to the private key such that the server obtains the second identity identifier according to the token and the signature, and performs identity authentication according to the first identity identifier and the second identity identifier.

In an embodiment, no password is transmitted during communication between the authentication end and the server, which can avoid account security issues caused by leakage of authentication information and further improves security of identity authentication.

In an embodiment, the server need not store the password, which can avoid account security issues caused by leakage of authentication information and further improve security of identity authentication.

### BRIEF DESCRIPTION OF THE SEVERAL VIEWS OF THE DRAWINGS

To illustrate the technical solutions in the example embodiments more clearly, accompanying drawings that need to be used in the description of the embodiments or the prior art are briefly introduced below. Obviously, the accompanying drawings in the following description are merely some embodiments. Persons of ordinary skill in the art may further obtain other drawings according to these accompanying drawings without making creative efforts.

FIG. 1 illustrates a flowchart of an identity authentication method according to an embodiment;

FIG. 2 illustrates a flowchart of an embodiment of an integrated arrangement of an authentication end and a client in the embodiment as illustrated in FIG. 1;

FIG. 3 illustrates a flowchart of an embodiment of a separate arrangement of the authentication end and the client in the embodiment as illustrated in FIG. 1;

FIG. 4 illustrates a structural schematic view of an identity authentication apparatus according to an embodiment;

FIG. 5 illustrates a structural schematic view of an identity authentication apparatus according to an embodiment;

FIG. 6 illustrates a structural schematic view of a server according to an embodiment.

### DETAILED DESCRIPTION

To make the purposes, technical solutions, and advantages of the embodiments more clearly, the technical solutions in the embodiments are clearly and completely described with the accompanying drawings in the example embodiments. Evidently, the embodiments to be described are part of rather than all of the embodiments. All other embodiments obtained by persons of ordinary skill in the art based on the embodiments of the present disclosure without making creative efforts shall fall within the protection scope of the present disclosure.

Noticeably, terminals involved in embodiments may include, but are not limited to mobile phones, personal digital assistants PDAs, wireless handheld devices, personal computers, portable computers, MP3 player and MP4 players.

In addition, the term “and/or” herein merely describes an association relationship between associated objects, indicating that three types of relationships may exist, for example, A and/or B may represent three cases where only A exists, both A and B exist, and only B exists. In addition, the symbol “/” herein generally represents an “or” relationship between associated objects before and after “/”.

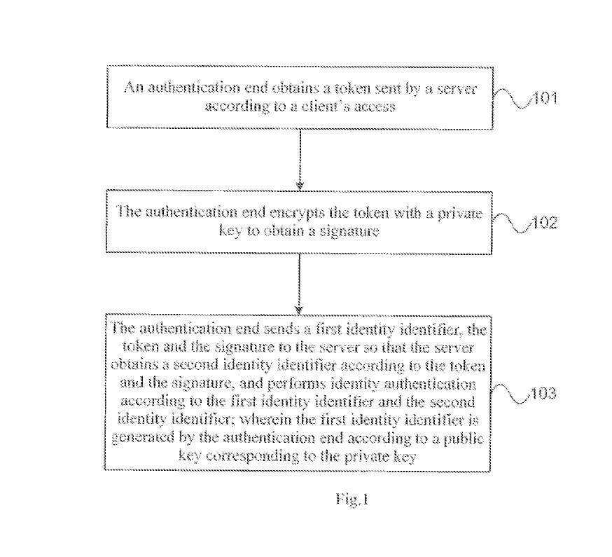

FIG. 1 illustrates a flowchart of an identity authentication method according to an embodiment.

Step 101: an authentication end obtains a token sent by a server according to a client's access.

The token may be a sole a character string and is used to identify the client. Once the identity authentication passes, the client carries this token to indicate its identity during subsequent communication with the server.

Step 102: the authentication end encrypts the token with a private key to obtain a signature.

Step 103: the authentication end sends a first identity identifier, the token and the signature to the server so that the server obtains a second identity identifier according to the token and the signature, and performs identity authentication according to the first identity identifier and the second identity identifier; wherein the first identity identifier is generated by the authentication end according to a public key corresponding to the private key.

The authentication end may send to the server HyperText Transfer Protocol HTTP GET request or HTTP POST request to carry the first identity identifier, the token and the signature. It may be appreciated that the HTTP GET request or HTTP POST request may further carry position information of the terminal where the client is located, for example, longitude information and latitude information.

It may be appreciated that the client may be an application installed on the terminal, or may be a webpage of a browser, so long as it can perform services that can be provided by the server to provide objective existence forms of corresponding services. The present embodiment does not limit this.

As such, inconvenience of input of authentication information via the input device and easy occurrence of errors in the prior art may be avoided and thereby efficiency and reliability of identity authentication may be improved in the following manner: the authentication end encrypts the obtained token with a private key to obtain a signature so that the authentication end can send to the server the first identity identifier, the token and the signature generated according to the public key corresponding to the private key such that the server obtains the second identity identifier according to the token and the signature, and performs identity authentication according to the first identity identifier and the second identity identifier.

In an embodiment, no password is transmitted during communication between the authentication end and the server, which may avoid account security issues caused by leakage of authentication information and further improves security of identity authentication.

In an embodiment, the server need not store the password, which can avoid account security issues caused by leakage of authentication information and further improve security of identity authentication.

In an embodiment, in step 102, the authentication end may perform Hash operations for the token to obtain a Hash value of the token. However, the authentication end may use the private key to encrypt the Hash value of the token to obtain the signature.

Correspondingly, after step 103, the server may perform Hash operations for the token to obtain the Hash value of the token, and furthermore, the server may obtain the public key corresponding to the signature according to the Hash value of the token and the signature. Then the server may generate the second identity identifier according to the public key corresponding to the signature. If the second identity identifier accords with the first identity identifier, the server may perform an operation of passing the identity authentication.

In an embodiment, when the user executes registration operation for the first time or performs a certain identity authentication operation, the server may record the user's first identity identifier and user account and associate them to maintain a correspondence relationship between the first identity identifier and the user account. The server may obtain the user account corresponding to the first identity identifier according to the first identity identifier. Then, the server may send service data related to the user account to the client.

In an embodiment, before step 102, the authentication end, according to a website to be accessed, selects a set of secret key information as the private key and the public key corresponding to the private key. For example, if the website to be accessed is sina microblog, the authentication end may select a set of secret key information A, or for example, if the website to be accessed is Taobao, the authentication end may select a set of secrete key information B.

In an embodiment, before this, a plurality of sets of secret key information may be pre-generated for selection by the authentication end according to the website to be accessed. As such, the authentication end may uniformly manage all the user's accounts and the user himself need not manage the accounts respectively, which can further improve efficiency of identity authentication. To further improve security of identity authentication, high-security encryption and decryption algorithm may be further employed to encrypt the plurality of sets of secret key information so that the authentication end only needs to maintain one password to achieve uniform management of all the user's accounts.

In an embodiment, the authentication end may be set in a local client. In this way, since the authentication end is integrated with the client, identity authentication operation may be executed automatically during the client's running to further improve the efficiency of the identity authentication.

For example, the client uses a browser to open a page of a target website to visit the target website, a server of the target website receives an access request sent from the client, detects that the access request does not carry a token, allocates a token T to the client and then sends to the client a Uniform Resource Locator URL sent back from the token T and authentication data. The client records the token T, for example in a Cookie of the browser, for subsequent communication with the server.

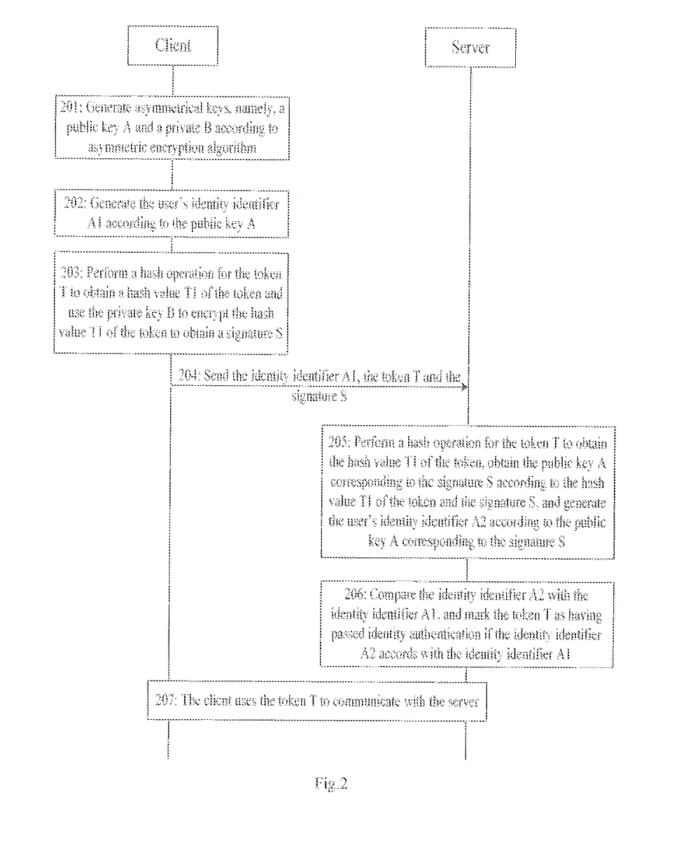

As shown in FIG. 2, in an embodiment the following operations are performed:

Step 201: The client generates asymmetrical keys, namely, a public key A and a private B according to asymmetric encryption algorithm.

Step 202: The client generates the user's identity identifier A1 according to the public key A.

For example, the client performs a hash operation for the public key A to obtain the identity identifier A1.

Step 203: After obtaining the token T, the client performs a hash operation for the token T to obtain a hash value T1 of the token and uses the private key B to encrypt the hash value T1 of the token to obtain a signature S.

Step 204: The client sends the identity identifier A1, the token T and the signature S to the server according to the URL sent back from the authentication data.

Step 205: The server performs a hash operation for the token T to obtain the hash value T1 of the token, obtains the public key A corresponding to the signature S according to the hash value T1 of the token and the signature S, and generates the user's identity identifier A2 according to the public key A corresponding to the signature S.

Step 206: The server compares the identity identifier A2 with the identity identifier A1, and marks the token T as having passed identity authentication if the identity identifier A2 accords with the identity identifier A1.

Alternatively, the server may further send to the client an indication of the passing of identity authentication.

Step 207: The client uses the token T to communicate with the server.

In an embodiment, the client may periodically attempt to use the token T to communicate with the server, and may successfully communicate with the server once the server marks the token T as having passed identity authentication. Alternatively, after receiving an indication that identity authentication has passed, the client uses the token T to communicate with the server.

So far, the server may perform an operation of passing the identity authentication. For example, the server may, according to the identity identifier A1, obtain a user account corresponding to the identity identifier A1 and send to the client service data related to the user account.

In an embodiment, the authentication end may further be provided independently from a local client. As such, the authentication end and the client are provided separately, key data such as the private key and the public key on which the identity authentication relies on may separate from the client so that the security of identity authentication may be further improved.

For example, the client uses a browser to open a page of a target website to visit the target website, a server of the target website receives an access request sent from the client, detects that the access request does not carry a token, allocates a token T to the client and then sends to the client a Uniform Resource Locator URL sent back from the token T and authentication data in a QR code. The client records the token T, for example in a Cookie of the browser, for subsequent communication with the server. The client exhibits the received QR code in the page. As shown in FIG. 3, the following operations may be performed:

Step 301: The authentication end generates asymmetrical keys, namely, a public key A and a private B according to asymmetric encryption algorithm.

Step 302: The authentication end generates the user's identity identifier A1 according to the public key A.

For example, the authentication end performs hash operation for the public key A to obtain the identity identifier A1.

Step 303: the authentication end, according to the QR code exhibited by the client, obtains the URL sent back from the token T and the authentication data.

Step 304: the authentication end performs hash operation for the token T to obtain a hash value T1 of the token and uses the private key B to encrypt the hash value T1 of token to obtain a signature S.

Step 305: The authentication end sends the identity identifier A1, the token T and the signature S to the server according to the URL sent back from the authentication data.

Step 306: The server performs hash operation for the token T to obtain the hash value T1 of the token, obtains the public key A corresponding to the signature S according to the hash value T1 of the token and the signature S, and generates the user's identity identifier A2 according to the public key A corresponding to the signature S.

Step 307: The server compares the identity identifier A2 with the identity identifier A1, and marks the token T as having passed identity authentication if the identity identifier A2 accords with the identity identifier A1.

Step 308: The client uses the token T to communicate with the server.

In an embodiment, the client may periodically attempt to use the token T to communicate with the server, and may successfully communicate with the server once the server marks the token T as having passed identity authentication.

So far, the server may perform an operation of passing the identity authentication. For example, the server may, according to the identity identifier A1, obtain a user account corresponding to the identity identifier A1 and send to the client service data related to the user account.

In this embodiment, the authentication end encrypts the obtained token with a private key to obtain a signature so that the authentication end can send to the server the first identity identifier, the token and the signature generated according to the public key corresponding to the private key such that the server obtains the second identity identifier according to the token and the signature, and performs identity authentication according to the first identity identifier and the second identity identifier. This can avoid inconvenience of input of authentication information via the input device and easy occurrence of errors in the prior art and thereby improves efficiency and reliability of identity authentication.

In an embodiment, no password is transmitted during communication between the authentication end and the server, which can avoid account security issues caused by leakage of authentication information and further improves security of identity authentication.

In an embodiment, the server need not store the password, which can avoid account security issues caused by leakage of authentication information and further improve security of identity authentication.

The above-mentioned method embodiments all are described as a combination of a series of actions for the sake of simple description, but those skilled in the art should know that the present disclosure is not limited to the described order of actions because some steps may be performed in other order or simultaneously according to various embodiments.

The above embodiments each are described with a different focus, and a portion not detailed in a certain embodiment may find relevant depictions in other embodiments.

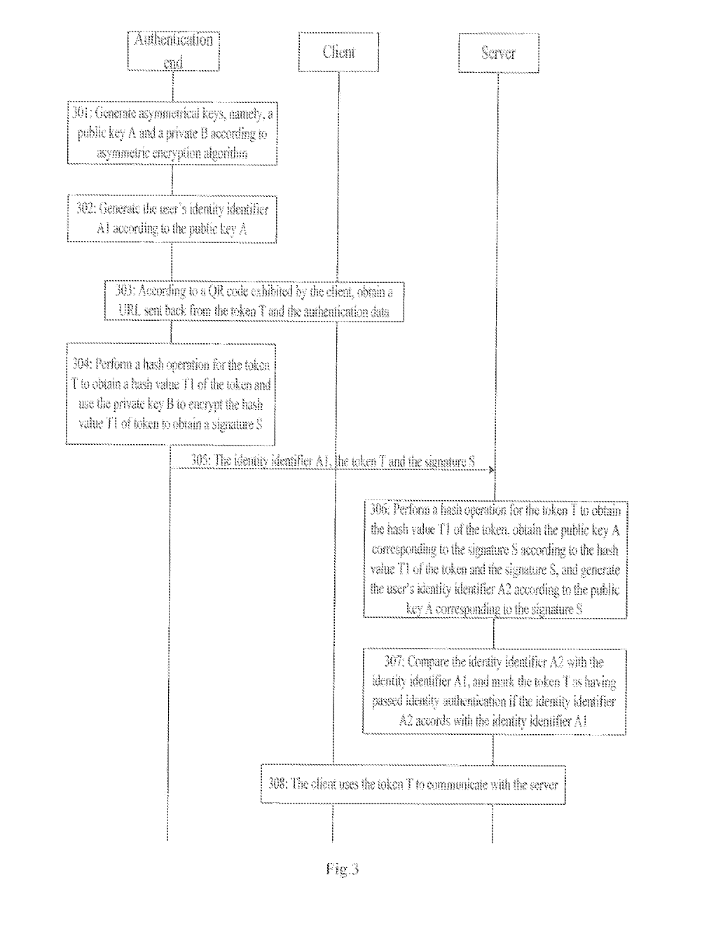

FIG. 4 illustrates a structural schematic view of an identity authentication apparatus according to an embodiment. The identity authentication apparatus according to the present embodiment may comprise an obtaining unit 41, a signing unit 42 and a sending unit 43, wherein the obtaining unit 41 is configured to obtain a token sent by a server according to a client's access behavior. The token may be a sole a character string and is used to identify the client. Once the identity authentication passes, the client carries this token to indicate its identity during subsequent communication with the server. The signing unit 42 is configured to encrypt the token with a private key to obtain a signature. The sending unit 43 is configured to send a first identity identifier, the token and the signature to the server so that the server obtains a second identity identifier according to the token and the signature, and performs identity authentication according to the first identity identifier and the second identity identifier; wherein the first identity identifier is generated according to a public key corresponding to the private key. The sending unit 43 may send to the server HyperText Transfer Protocol HTTP GET request or HTTP POST request to carry the first identity identifier, the token and the signature. It may be appreciated that the HTTP GET request or HTTP POST request may further carry position information of the terminal where the client is located, for example, longitude information and latitude information.

It may be appreciated that the client may be an application installed on the terminal, or may be a webpage of a browser, so long as it can perform services that can be provided by the server to provide objective existence forms of corresponding services. The present embodiment does not limit this.

In an embodiment, the signing unit encrypts the token obtained by the obtaining unit with a private key to obtain a signature so that the sending unit can send to the server the first identity identifier, the token and the signature generated according to the public key corresponding to the private key such that the server obtains the second identity identifier according to the token and the signature, and performs identity authentication according to the first identity identifier and the second identity identifier. This can avoid inconvenience of input of authentication information via the input device and easy occurrence of errors in the prior art and thereby improves efficiency and reliability of identity authentication.

In an embodiment, the server need not store the password, which can avoid account security issues caused by leakage of authentication information and further improve security of identity authentication.

In an embodiment, the signing unit 42 may perform Hash operations for the token to obtain a Hash value of the token; and use the private key to encrypt the Hash value of the token to obtain the signature.

Correspondingly, the server may perform Hash operations for the token to obtain the Hash value of the token, and furthermore, the server may obtain the public key corresponding to the signature according to the Hash value of the token and the signature. Then the server may generate the second identity identifier according to the public key corresponding to the signature. If the second identity identifier accords with the first identity identifier, the server may perform an operation of passing the identity authentication.

In an embodiment, when the user executes registration operation for the first time or performs a certain identity authentication operation, the server may record the user's first identity identifier and user account and associate them to maintain a correspondence relationship between the first identity identifier and the user account. The server may obtain the user account corresponding to the first identity identifier according to the first identity identifier. Then, the server may send service data related to the user account to the client.

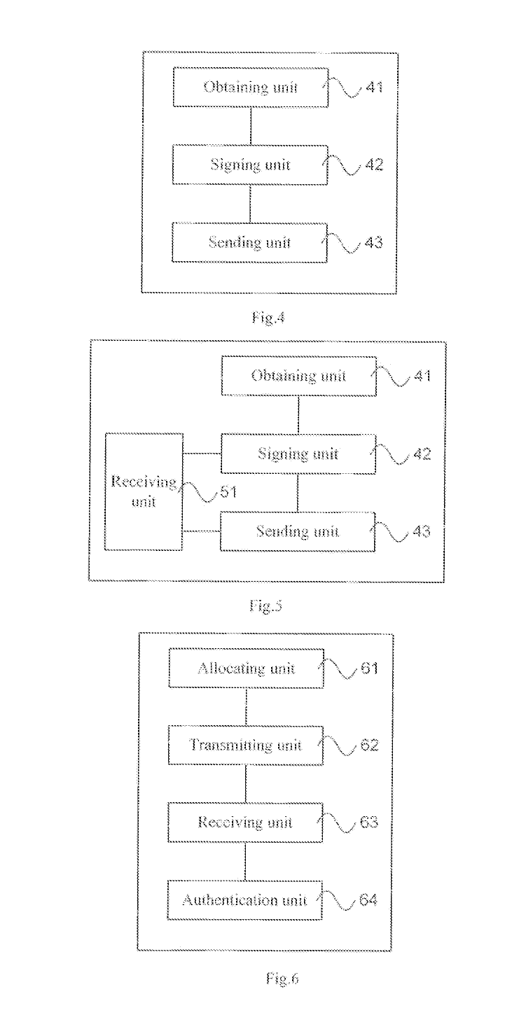

In an embodiment, as shown in FIG. 5, the identity authentication apparatus according to the present embodiment may further comprise a selecting unit 51 configured to, according to a website to be accessed, selects a set of secret key information as the private key and the public key corresponding to the private key. For example, if the website to be accessed is sina microblog, the selecting unit 51 may select a set of secret key information A, or for example, if the website to be accessed is Taobao, the selecting unit 51 may select a set of secrete key information B.

The identity authentication apparatus according to an embodiment may pre-generate a plurality of sets of secret key information for selection according to the website to be accessed. As such, the identity authentication apparatus may uniformly manage all the user's accounts and the user himself need not manage the accounts respectively, which can further improve efficiency of identity authentication. To further improve security of identity authentication, the identity identification apparatus may further employ high-security encryption and decryption algorithm to encrypt the plurality of sets of secret key information so that the identity identification device only needs to maintain one password to achieve uniform management of all the user's accounts.

In an embodiment, the identity authentication device may be set in a local client. In this way, since the identity authentication device is integrated with the client, identity authentication operation may be executed automatically during the client's running to further improve the efficiency of the identity authentication.

In an embodiment, the identity authentication device may further be provided independently from a local client. As such, the identity authentication device and the client are provided separately, key data such as the private key and the public key on which the identity authentication relies on may separate from the client so that the security of identity authentication may be further improved.

In an embodiment, the signing unit encrypts the token obtained by the obtaining unit with a private key to obtain a signature so that the sending unit can send to the server the first identity identifier, the token and the signature generated according to the public key corresponding to the private key such that the server obtains the second identity identifier according to the token and the signature, and performs identity authentication according to the first identity identifier and the second identity identifier. This can avoid inconvenience of input of authentication information via the input device and easy occurrence of errors in the prior art and thereby improves efficiency and reliability of identity authentication.

In an embodiment, the server need not store the password, which can avoid account security issues caused by leakage of authentication information and further improve security of identity authentication.

FIG. 6 illustrates a structural schematic view of a server according to an embodiment. The server of the present embodiment may comprise an allocating unit 61, a transmitting unit 62, a receiving unit 63 and an authentication unit 64, wherein the allocating unit 61 is configured to allocate a token to a client according to the client's access behavior. The token may be a sole a character string and is used to identify the client. Once the identity authentication passes, the client carries this token to indicate its identity during subsequent communication with the server. The transmitting unit 62 is configured to transmit the token to the authentication end so that the authentication end uses the private key to encrypt the token to obtain a signature. The receiving unit 63 is configured to receive the first identity identifier, the token and the signature transmitted by the authentication end, wherein the first identity identifier is generated by the authentication end according to the public key corresponding to the private key. The receiving unit 63 is configured to send to the server HyperText Transfer Protocol HTTP GET request or HTTP POST request to carry the first identity identifier, the token and the signature. It may be appreciated that the HTTP GET request or HTTP POST request may further carry position information of the terminal where the client is located, for example, longitude information and latitude information. The authentication unit 64 is configured to obtain a second identity identifier according to the token and the signature, and perform identity authentication according to the first identity identifier and the second identity identifier.

It may be appreciated that the client may be an application installed on the terminal, or may be a webpage of a browser, so long as it can perform services that can be provided by the server to provide objective existence forms of corresponding services. The present embodiment does not limit this.

In an embodiment, inconvenience of input of authentication information via the input device and easy occurrence of errors in the prior art may be avoided and efficiency and reliability of identity authentication may thereby be improved in the following manner: the allocating unit allocates a token to the client according to the client's access behavior, and then the transmitting unit transmits the token to the authentication end so that the authentication end uses the private key to encrypt the token to obtain a signature, and the receiving unit receives the first identity identifier, the token and the signature transmitted by the authentication end and generated according to the public key corresponding to the private key so that the authentication unit obtains the second identity identifier according to the token and the signature, and performs identity authentication according to the first identity identifier and the second identity identifier.

In an embodiment, no password is transmitted during communication between the authentication end and the server, which can avoid account security issues caused by leakage of authentication information and further improves security of identity authentication.

In an embodiment, the server need not store the password, which can avoid account security issues caused by leakage of authentication information and further improve security of identity authentication.

In an embodiment, the authentication end may perform Hash operations for the token to obtain a Hash value of the token. However, the authentication end may use the private key to encrypt the Hash value of the token to obtain the signature.

In an embodiment, the authentication unit 64 may perform Hash operations for the token to obtain the Hash value of the token; obtain the public key corresponding to the signature according to the Hash value of the token and the signature; generate the second identity identifier according to the public key corresponding to the signature; and perform an operation of passing the identity authentication if the second identity identifier accords with the first identity identifier.

In an embodiment, the authentication unit 64 may, when the user executes registration operation for the first time or performs a certain identity authentication operation, record the user's first identity identifier and user account and associate them to maintain a correspondence relationship between the first identity identifier and the user account. The authentication unit 64 may obtain the user account corresponding to the first identity identifier according to the first identity identifier, and then send service data related to the user account to the client.

In an embodiment, the authentication end, according to a website to be accessed, selects a set of secret key information as the private key and the public key corresponding to the private key. For example, if the website to be accessed is sina microblog, the authentication end may select a set of secret key information A, or for example, if the website to be accessed is Taobao, the authentication end may select a set of secrete key information B.

In an embodiment, before this, a plurality of sets of secret key information may be pre-generated for selection by the authentication end according to the website to be accessed. As such, the authentication end may uniformly manage all the user's accounts and the user himself need not manage the accounts respectively, which can further improve efficiency of identity authentication. To further improve security of identity authentication, high-security encryption and decryption algorithm may be further employed to encrypt the plurality of sets of secret key information so that the authentication end only needs to maintain one password to achieve uniform management of all the user's accounts.

In an embodiment, the authentication end may be set in a local client. In this way, since the authentication end is integrated with the client, identity authentication operation may be executed automatically during the client's running to further improve the efficiency of the identity authentication.

In an embodiment, the authentication end may further be provided independently from a local client. As such, the authentication end and the client are provided separately, key data such as the private key and the public key on which the identity authentication relies on may separate from the client so that the security of identity authentication may be further improved.

In this embodiment, inconvenience of input of authentication information via the input device and easy occurrence of errors in the prior art may be avoided and efficiency and reliability of identity authentication may thereby be improved in the following manner: the allocating unit allocates a token to the client according to the client's access behavior, and then the transmitting unit transmits the token to the authentication end so that the authentication end uses the private key to encrypt the token to obtain a signature, and the receiving unit receives the first identity identifier, the token and the signature transmitted by the authentication end and generated according to the public key corresponding to the private key so that the authentication unit obtains the second identity identifier according to the token and the signature, and performs identity authentication according to the first identity identifier and the second identity identifier.

In an embodiment, no password is transmitted during communication between the authentication end and the server, which can avoid account security issues caused by leakage of authentication information and further improves security of identity authentication.

In an embodiment, the server need not store the password, which can avoid account security issues caused by leakage of authentication information and further improve security of identity authentication.

Those skilled in the art may clearly understand that, for ease and concision of description, for a specific working process of the foregoing described system, apparatus, and unit, reference may be made to a corresponding process in the foregoing method embodiments, and details are not repeatedly described here.

In the several embodiments provided in this application, it should be understood that, the disclosed system, apparatus, and method may be implemented in other manners. For example, the foregoing described apparatus embodiment is only exemplary. For example, dividing of the units is only a type of dividing of logical functions. In actual implementation, there may be other dividing methods. For example, a plurality of units or components may be combined or integrated into another system, or some features may be ignored, or may not be executed. In addition, the shown or discussed mutual coupling, or direct coupling, or communication connection may be implemented through some interfaces, and indirect coupling or communication connection of apparatuses or units may be electrical, mechanical, or in other forms.

The units that are described as separate components may be or may not be physically separated, and the components shown as units may be or may not be physical units, that is, may be located at one place, or may also be distributed on multiple network units. Part of or all of the units may be selected, according to an actual need, to achieve the purposes of the solutions in the embodiments.

In addition, function units in each embodiment may be integrated into a processing unit, and each unit may also exist independently and physically, and two or more than two units may also be integrated into one unit. The foregoing integrated unit may be implemented in the form of hardware, and may also be implemented in the form of hardware plus a software function unit.

The foregoing integrated unit implemented in the form of the software function unit may be stored in a computer readable storage medium. The software function unit is stored in a storage medium, including several instructions used for a computer device (which may be a personal computer, a server, or a network device, and so on) and a processor to execute part of the steps of the method in various embodiments. The foregoing storage medium includes various media that can store procedure codes, such as a USB disk, a portable hard disk, a read only memory (Read-Only Memory, abbreviated as ROM), a random access memory (Random Access Memory, abbreviated as RAM), a magnetic disk, or a compact disk.

Finally, it should be noted that: the foregoing embodiments are only intended to explain the technical solutions in the present disclosure, but not intended to limit it. Although the present disclosure includes descriptions in detail with reference to the foregoing embodiments, persons of ordinary skill in the art should understand that, they may still make modifications to the technical solutions recorded in the foregoing embodiments, or equivalent replacements to part of the technical features in the technical solutions recorded in the foregoing embodiments; however, these modifications or replacements do not make the nature of the corresponding technical solutions depart from the spirit and scope of the technical solutions in the embodiments.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. An identity authentication method, comprising:
an authentication end obtaining a token sent by a server according to a client's access;
the authentication end encrypting the token with a private key to obtain a signature; and
the authentication end sending a first identity identifier, the token and the signature to the server so that the server obtains a second identity identifier according to the token and the signature, and performs identity authentication according to the first identity identifier and the second identity identifier, wherein the first identity identifier is generated by the authentication end according to a public key corresponding to the private key.

2. The method according to claim 1 wherein the authentication end is provided in the client or independently from the client.

3. The method according to claim 1 wherein the step of the authentication end encrypting the token with a private key to obtain a signature comprises:
the authentication end performing a Hash operation for the token to obtain a Hash value of the token; and
the authentication end using the private key to encrypt the Hash value of the token to obtain the signature.

4. The method according to claim 3 wherein the step of the server obtaining a second identity identifier according to the token and the signature, and performing identity authentication according to the first identity identifier and the second identity identifier comprises:
the server performing a Hash operation for the token to obtain a Hash value of the token;
the server obtaining the public key corresponding to the signature according to the Hash value of the token and the signature;
the server generating the second identity identifier according to the public key corresponding to the signature; and
the server performing an operation of passing the identity authentication if the second identity identifier accords with the first identity identifier.

5. The method according to claim 1 wherein before the authentication end encrypts the token with a private key to obtain the signature, the method further comprises:
the authentication end, according to a website to be accessed, selecting a set of secret key information as the private key and the public key corresponding to the private key.

6. The method according to claim 1 wherein the step of the server performing an operation of passing the identity authentication comprises:
the server obtaining a user account corresponding to the first identity identifier according to the first identity identifier; and
the server sending service data related to the user account to the client.

7. An identity authentication apparatus, comprising:
an obtaining unit configured to obtain a token sent by a server according to a client's access behavior;
a signing unit configured to encrypt the token with a private key to obtain a signature; and
a sending unit configured to send a first identity identifier, the token and the signature to the server so that the server obtains a second identity identifier according to the token and the signature, and performs identity authentication according to the first identity identifier and the second identity identifier; wherein the first identity identifier is generated according to a public key corresponding to the private key.

8. The identity authentication apparatus according to claim 7 wherein the authentication apparatus is provided in the client or independently from the client.

9. The identity authentication apparatus according to claim 7 wherein the signing unit is configured to
perform a Hash operation for the token to obtain a Hash value of the token; and
use the private key to encrypt the Hash value of the token to obtain the signature.

10. The identity authentication apparatus according to claim 7 wherein the apparatus further comprises a selection unit configured to,
according to a website to be accessed, select a set of secret key information as the private key and the public key corresponding to the private key.

11. A server, comprising:
an allocating unit configured to allocate a token to a client according to the client's access behavior;
a transmitting unit configured to transmit the token to an authentication end so that the authentication end uses the private key to encrypt the token to obtain a signature;
a receiving unit configured to receive the first identity identifier, the token and the signature transmitted by the authentication end, wherein the first identity identifier is generated by the authentication end according to the public key corresponding to the private key; and
an authentication unit configured to obtain a second identity identifier according to the token and the signature, and perform identity authentication according to the first identity identifier and the second identity identifier.

12. The server according to claim 11 wherein the authentication unit is configured to
perform a Hash operation for the token to obtain a Hash value of the token;
obtain the public key corresponding to the signature according to the Hash value of the token and the signature;
generate the second identity identifier according to the public key corresponding to the signature; and
perform an operation of passing the identity authentication if the second identity identifier accords with the first identity identifier.

13. The server according to claim 11 wherein the authentication unit is configured to
obtain a user account corresponding to the first identity identifier according to the first identity identifier; and
send service data related to the user account to the client.
